(19) United States
(12) Patent Application Publication
(10) Pub. No.: US 2009/0088007 A1
(43) Pub. Date: Apr. 2, 2009

(54) Printed Circuit Board Assembly and Electronic Device

(76) Inventor: Tsung-Sheng Tsai, Hsinchu City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/031,797

(22) Filed: Feb. 15, 2008

(30) Foreign Application Priority Data
Sep. 28, 2007 (TW) 096216236

(51) Int. Cl. H01R 12/00

(52) U.S. Cl. 439/67

(57) ABSTRACT

This invention is to provide a printed circuit board assembly, comprising: a flexible printed circuit board comprising a first electrical connection end and a second electrical connection end; a printed circuit board electrically connected to the second electrical connection end; a frame comprising a first protrusion for maintaining the relative positions of the second electrical connection end and the printed circuit board; and a fastener passing through the second electrical connection end and the printed circuit board for fastening the second electrical connection end and the printed circuit board to the frame.

### BACKGROUND OF THE INVENTION

1. Field of the Invention

The present invention relates to a printed circuit board assembly; more particularly, it relates to a printed circuit board assembly in which the combination of a flexible printed circuit board and a printed circuit board is carried out by a passing-through configuration.

2. Description of the Related Art

A flexible printed circuit board, which is a printed circuit fabricated of soft insulated material, possesses several advantages over a traditional, rigid printed circuit board. For example, a flexible printed circuit board may be bent, rolled, or stacked freely; in addition, it can be compressed and stretched arbitrarily to meet the needs of a certain spatial arrangement, providing an integral configuration of parts and wires. By the aforementioned characteristics, the use of flexible printed circuit boards largely reduces the sizes of various electronic products and proffers them with desirable properties such as high density, miniaturization, and high reliability.

Traditionally, the connection between a flexible printed circuit board and a printed circuit board is achieved by the use of a connector. Take a digital camera for example. As shown in FIG. 1, an electronic component 100 (which is a lens in this example) is connected to one end of a flexible printed circuit board 10P via soldering or other means, and the other end of the flexible printed circuit board 10P is inserted into a connector 110 mounted on a printed circuit board 20P. Therefore, to set up the electrical connection between a flexible printed circuit board and a printed circuit board by the traditional process, a connector needs to be soldered onto the printed circuit board in advance so that the flexible printed circuit board can be inserted into the connector during the assembly procedure.

However, due to the use of connectors, connector fabrication steps and soldering steps are inevitably included in the traditional process, largely increasing the costs and complexity of the process. Furthermore, flexible printed circuit boards are often damaged during the insertion step.

### SUMMARY OF THE INVENTION

It is therefore an object of the present invention to provide a printed circuit board assembly in which the connection between a flexible printed circuit board and a printed circuit board may be carried out without a connector.

It is another object of the present invention to provide a printed circuit board assembly capable of simplifying the fabrication process of electronic devices containing flexible printed circuit boards; meanwhile, the loss of flexible printed circuit boards to damage during fabrication can also be prevented substantially.

It is still another object of the present invention to provide an electronic device in which the electrical connection between a flexible printed circuit board and a printed circuit board is made by means of fastening; thus, a simplified fabrication process may be obtained thereby.

To achieve the above-mentioned objects, this invention provides a printed circuit board assembly electrically connectable to an electronic component, the printed circuit board assembly comprising: a flexible printed circuit board comprising a first electrical connection end and a second electrical connection end, wherein the first electrical connection end is electrically connected to the electronic component, and the second electrical connection end has a first positioning hole and a first fastening hole; a printed circuit board electrically connected to the second electrical connection end, the printed circuit board comprising a second positioning hole and a second fastening hole, wherein the second positioning hole corresponds to the first positioning hole, and the second fastening hole corresponds to the first fastening hole; a frame comprising a third fastening hole and a first protrusion, the first protrusion passing through the first and the second positioning holes; and a fastener passing through the first, the second, and the third fastening holes, the fastener being adapted to stabilize the electrical connection between the flexible printed circuit board and the printed circuit board.

Moreover, the present invention also provides a printed circuit board assembly mainly comprising: a flexible printed circuit board comprising a first electrical connection end and a second electrical connection end; a printed circuit board electrically connected to the second electrical connection end; a frame comprising a first protrusion for maintaining the relative positions of the second electrical connection end and the printed circuit board; and a fastener passing through the second electrical connection end and the printed circuit board for fastening the second electrical connection end and the printed circuit board to the frame.

Additionally, the present invention provides an electronic device comprising: an electronic component; a flexible printed circuit board comprising a first electrical connection end and a second electrical connection end, the first electrical connection end being electrically connected to the electronic component; a printed circuit board electrically connected to the second electrical connection end; a frame comprising a first protrusion for maintaining the relative positions of the second electrical connection end and the printed circuit board; and a fastener passing through the second electrical connection end and the printed circuit board for fastening the second electrical connection end and the printed circuit board to the frame.

Other objects, advantages, and novel features of the invention will become more apparent from the following detailed description when taken in conjunction with the accompanying drawings.

### BRIEF DESCRIPTION OF THE DRAWINGS

The accompanying drawings, which are included in and constitute a part of this specification, illustrate the embodiments of the invention and, together with the description, explain the features and principles of the invention. In the drawings:

FIG. 1 is an illustration of known printed circuit board assembly.

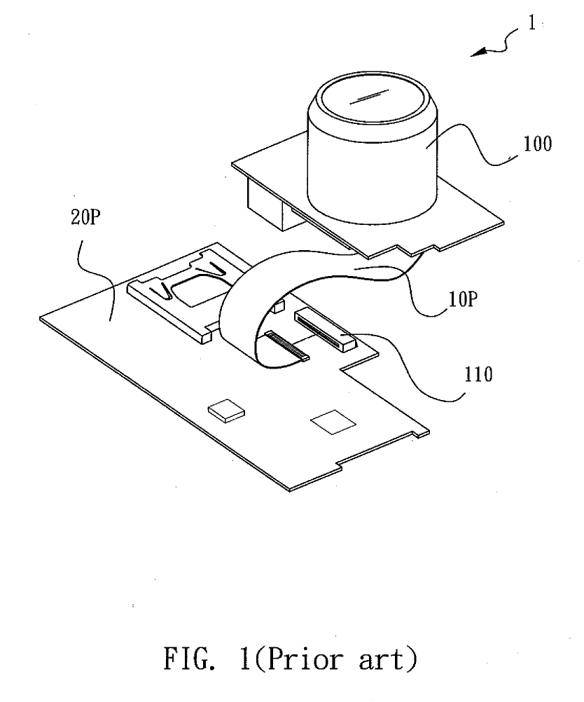

FIG. 2 is an exploded view of one embodiment of the printed circuit board assembly of this invention.

FIG. 3 is a sectional view of one embodiment of the printed circuit board assembly of this invention.

FIG. 4 is a sectional view of another embodiment of the printed circuit board assembly of this invention.

FIG. 5 is an illustration of one embodiment of the electronic device of this invention.

### DETAILED DESCRIPTION OF THE PREFERRED EMBODIMENT

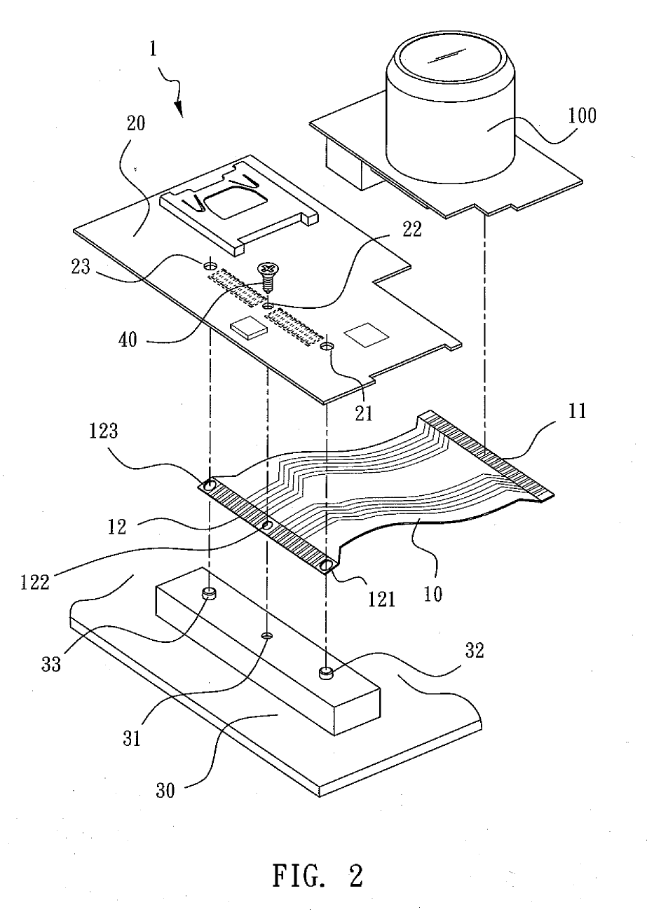

Please refer to FIG. 2 for an exploded view of one embodiment of the printed circuit board assembly 1 of this invention. As shown, the printed circuit board assembly 1, which is electrically connectable to an electronic component 100 (which is a lens in this embodiment), mainly comprises a flexible printed circuit board 10 comprising a first electrical connection end 11 and a second electrical connection end 12, wherein the first electrical connection end 11 is electrically connected to the electronic component 100, and the second electrical connection end 12 has a first positioning hole 121 and a first fastening hole 122; a printed circuit board 20 electrically connected to the second electrical connection end 12, the printed circuit board 20 comprising a second positioning hole 21 and a second fastening hole 22, wherein the second positioning hole 21 corresponds to the first positioning hole 121, and the second fastening hole 22 corresponds to the first fastening hole 122; a frame 30 comprising a third fastening hole 31 and a first protrusion 32, the first protrusion 32 passing through the first positioning hole 121 and the second positioning hole 21; and a fastener 40 passing through the first fastening hole 122, the second fastening hole 22, and the third fastening hole 31, the fastener 40 being adapted to stabilize the electrical connection between the flexible printed circuit board 10 and the printed circuit board 20.

It should be noted that although a lens of a digital camera is adapted to represent the electronic component 100, the printed circuit board assembly 1 of this invention is not limited to the application of a digital camera. In other words, any electronic device containing a flexible printed circuit board 10 and a printed circuit board 20, such as laptop computers, mobile phones, MP3 players, and so on, shall fall within the scope of this invention.

In this invention, the frame 30 may be any structure for securing the flexible printed circuit board 10 and the printed circuit board 20, such as the case or the internal compartment board of an electronic device. Similarly, the electrical connection between the first electrical connection end 11 and the electronic component 100 may be achieved by various ways, such as soldering or other known means.

By the aforementioned configuration, a user may first place the first positioning hole 121 of the flexible printed circuit board 10 over the first protrusion 32 when he/she is to assemble the printed circuit board assembly 1 of this invention. Then the user may place the second positioning hole 21 of the printed circuit board 20 over the first protrusion 32 so as to preliminary connect the flexible printed circuit board 10 and the printed circuit board 20. After that, the fastener 40 is used to stably connect the flexible printed circuit board 10 and the printed circuit board 20.

In this invention, the electrical connection between the second electrical connection end 12 and the printed circuit board 20 can be made by a variety of ways, such as gold plating. Preferably, carbon printing may be without limitation employed to form electrically conductive pads on the surface of the second electrical connection end 12 and the printed circuit board 20. In addition, the fastener 40 may be any element capable of fastening the flexible printed circuit board 10, the printed circuit board 20, and the frame 30. For example, the fastener 40 may be but is not limited to a screw or a bolt.

To enhance the stability of the structure, the frame 30 may further comprise a second protrusion 33. In this case, the second electrical connection end 12 may further comprise a third positioning hole 123, and the printed circuit board 20 may further comprise a fourth positioning hole 23 that corresponds to the third positioning hole 123, wherein the second protrusion 33 passes through the third positioning hole 123 and the fourth positioning hole 23.

In most cases, the positions of the positioning holes and the fastening holes are not specified. In a preferable case, however, the first fastening hole 122 is disposed between the first positioning hole 121 and the third positioning hole 123, the second fastening hole 22 is disposed between the second positioning hole 21 and the fourth positioning hole 23, and the third fastening hole 31 is disposed between the first protrusion 32 and the second protrusion 33.

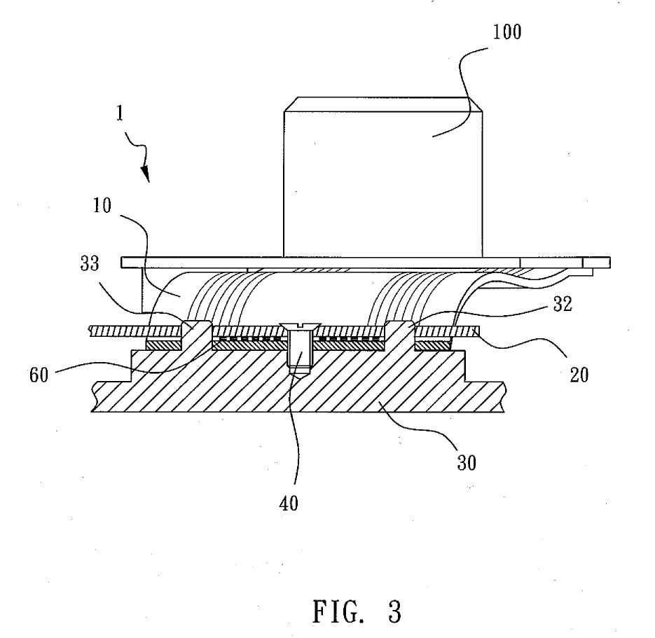

Please refer to FIG. 3 for a sectional view of one embodiment of the printed circuit board assembly 1 of this invention. In this embodiment, the flexible printed circuit board 10 is installed between the printed circuit board 20 and the frame 30. Thus, when fastened, the fastener 40 may sequentially pass through the printed circuit board 20, the flexible printed circuit board 10, and the frame 30, tightly combining the printed circuit board 20 and the flexible printed circuit board 10. Also, the pads 60 therebetween are firmly connected, ensuring a stable electrical connection to be formed between the printed circuit board 20 and the flexible printed circuit board 10.

In the meantime, with the use of fastening holes an d positioning holes and the protrusions 32, 33 of the frame 30, the printed circuit board assembly 1 of this invention may largely simplify the often complicated assembly procedure. Furthermore, by the removal of connectors, the present invention may reduce the complexity of the traditional process.

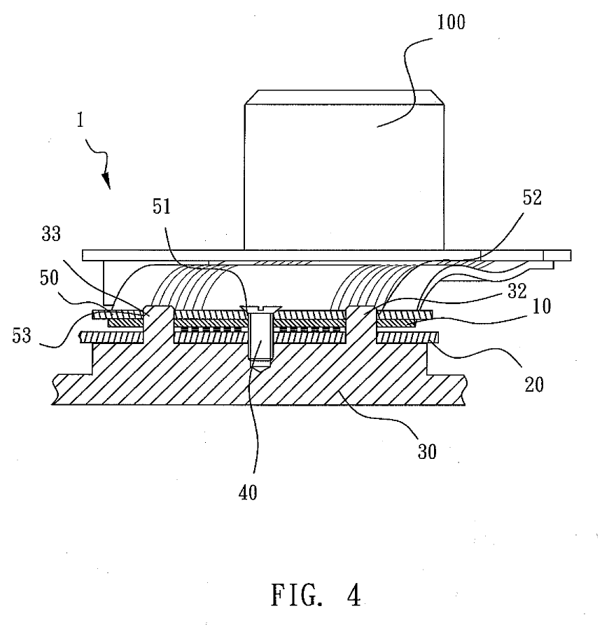

Now, please refer to FIG. 4 for a sectional view of another embodiment of the printed circuit board assembly 1 of this invention. Unlike the previous embodiment, here the printed circuit board 20 is disposed between the flexible printed circuit board 10 and the frame 30. Owing to the pliable characteristic of the flexible printed circuit board 10, it is not favored to fasten the flexible printed circuit board 10 directly on the printed circuit board 20 with the fastener 40. Thus, a reinforcement board 50 may be provided on the flexible printed circuit board 10. The reinforcement board 50 may comprise a fourth fastening hole 51, a fifth positioning hole 52, and a sixth positioning hole 53 penetrable by the fastener 40 and the protrusions 32, 33.

Therefore, the printed circuit board assembly 1 of this invention is applicable both to a structure where the flexible printed circuit board 10 is sandwiched in between the printed circuit board 20 and the frame 30 and to a structure where the flexible printed circuit board 10 is disposed on the printed circuit board 20 and the frame 30.

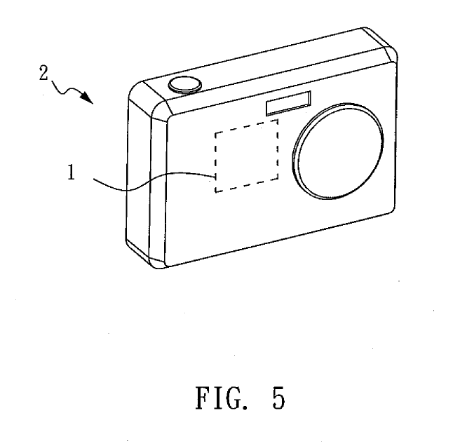

Finally, please refer to FIG. 5 for an illustration of one embodiment of the electronic device 2 of this invention. As shown in FIG. 5, the electronic device 2 has a printed circuit board assembly 1, mentioned above. What should be emphasized is that even though a digital camera is illustrated in FIG. 5, the electronic device 2 is not limited to it. Any electronic device having the printed circuit board assembly 1, such as laptop computers, mobile phones, MP3 players, and so on, shall fall within the scope of this invention.

It will be understood that many other modifications can be made to the various disclosed embodiments without departing from the spirit and scope of the invention. For these reasons, the above description should not be construed as limiting the invention, but should be interpreted as merely exemplary of preferred embodiments.

What is claimed is:

1. A printed circuit board assembly electrically connectable to an electronic component, the printed circuit board assembly comprising:
a flexible printed circuit board comprising a first electrical connection end and a second electrical connection end, wherein the first electrical connection end is electrically connected to the electronic component, and the second electrical connection end has a first positioning hole and a first fastening hole;
a printed circuit board electrically connected to the second electrical connection end, the printed circuit board comprising a second positioning hole and a second fastening hole, wherein the second positioning hole corresponds to the first positioning hole, and the second fastening hole corresponds to the first fastening hole;
a frame comprising a third fastening hole and a first protrusion, the first protrusion passing through the first and the second positioning holes; and
a fastener passing through the first, the second, and the third fastening holes, the fastener being adapted to stabilize the electrical connection between the flexible printed circuit board and the printed circuit board.

2. The printed circuit board assembly as claimed in claim 1, wherein the frame further comprises a second protrusion, the second electrical connection end further comprises a third positioning hole, and the printed circuit board further comprises a fourth positioning hole corresponding to the third positioning hole, the second protrusion passing through the third and the fourth positioning holes.

3. The printed circuit board assembly as claimed in claim 2, wherein the first fastening hole is disposed between the first and the third positioning holes, the second fastening hole is disposed between the second and the fourth positioning holes, and the third fastening hole is disposed between the first and the second protrusions.

4. The printed circuit board assembly as claimed in claim 1, wherein the electrical connection between the printed circuit board and the second electrical connection end is carried out by carbon printing.

5. The printed circuit board assembly as claimed in claim 1, wherein the fastener is a screw.

6. The printed circuit board assembly as claimed in claim 1, wherein the electronic component is a lens.

7. The printed circuit board assembly as claimed in claim 1, further comprising a reinforcement board comprising a fourth fastening hole, the fastener sequentially passing through the fourth, the first, the second, and the third fastening holes.

8. The printed circuit board assembly as claimed in claim 7, wherein the reinforcement board comprises a fifth positioning hole and a sixth positioning hole between which the fourth fastening hole is disposed.

9. The printed circuit board assembly as claimed in claim 1, wherein the second electrical connection end is disposed between the printed circuit board and the frame.

10. A printed circuit board assembly, comprising:
a flexible printed circuit board comprising a first electrical connection end and a second electrical connection end;
a printed circuit board electrically connected to the second electrical connection end;
a frame comprising a first protrusion for maintaining the relative positions of the second electrical connection end and the printed circuit board; and
a fastener passing through the second electrical connection end and the printed circuit board for fastening the second electrical connection end and the printed circuit board to the frame.

11. The printed circuit board assembly as claimed in claim 10, further comprising a reinforcement board disposed between the fastener and the flexible printed circuit board.

12. The printed circuit board assembly as claimed in claim 10, wherein the frame further comprises a second protrusion for maintaining the relative positions of the second electrical connection end and the printed circuit board.

13. The printed circuit board assembly as claimed in claim 10, wherein the fastener is a screw.

14. The printed circuit board assembly as claimed in claim 10, wherein the electrical connection between the printed circuit board and the second electrical connection end is carried out by carbon printing.

15. An electronic device, comprising:
an electronic component;
a flexible printed circuit board comprising a first electrical connection end and a second electrical connection end, the first electrical connection end being electrically connected to the electronic component;
a printed circuit board electrically connected to the second electrical connection end;
a frame comprising a first protrusion for maintaining the relative positions of the second electrical connection end and the printed circuit board; and
a fastener passing through the second electrical connection end and the printed circuit board for fastening the second electrical connection end and the printed circuit board to the frame.

16. The electronic device as claimed in claim 15, wherein the frame further comprises a second protrusion for maintaining the relative positions of the second electrical connection end and the printed circuit board.

17. The electronic device as claimed in claim 15, further comprising a reinforcement board disposed between the fastener and the flexible printed circuit board.

18. The electronic device as claimed in claim 15, which is a digital camera.

19. The electronic device as claimed in claim 15, wherein the fastener is a screw.

20. The electronic device as claimed in claim 15, wherein the electrical connection between the printed circuit board and the second electrical connection end is carried out by carbon printing.
